(19) United States
(12) Patent Application Publication
(10) Pub. No.: US 2009/0172979 A1
(43) Pub. Date: Jul. 9, 2009

(54) DISPLAYING GAIN STRUCTURE FOR AN ELECTORNIC NAMEPLATE

(76) Inventors: Andy KAOH, Taipei City (TW); Shieh-Hwei Lee Chen, Taipei City (TW)

Correspondence Address: Andy KAOH, 235 Chung - Ho, Box 8-24, Taipei, TW

(21) Appl. No.: 11/969,916

(22) Filed: Jan. 6, 2008

(51) Int. Cl. G09F 3/08

(52) U.S. Cl. 40/447

(57) ABSTRACT

A displaying gain structure for an electronic nameplate includes a circuit board, a magnet assembly and a cover plate. The circuit board includes an LED portion on its front side, and a control element, an information access port, a battery holder and a switch on its back side to control operation of the LED portion. The magnet assembly includes a magnet unit and a metal sheet disposed on the back side of the circuit board, and is attached to clothes of a user by attraction between the magnet unit and the metal sheet such that information displayed by the LED portion is observable. The cover plate is mounted to the LED portion by an intermediate member and spaced apart from the circuit board by a distance. The cover plate further includes an optical display interface to enhance its optical gain.

### BACKGROUND OF THE INVENTION

1. Field of the Invention

The present invention relates to a displaying gain structure for an electronic nameplate, mid more particularly, to a displaying gain structure for an electronic nameplate that includes a cover plate mounted to an LED portion on a circuit board through an intermediate member, spaced apart from the circuit board by a distance, and further including an optical display interface to enhance the optical gain thereof.

2. Description of Related Art

In today's world of highly developed economies, exhibitions or gatherings are often held in people's daily life. During these exhibitions or gatherings, people often do advertising to gain other's attention. In this situation, if an electronic nameplate is tagged on clothes of a user, the advertising would gain more attention.

FIGS. 1 and 2 illustrate perspective and side views of a conventional nameplate. The conventional nameplate may typically include a semitransparent plate 100 to protect an LED portion 200. However, the semitransparent plate 100 includes a smooth flat surface 300 and, as the light emitted by the LED portion 200 on a circuit board 400 transmits through the smooth flat surface 300, it produces boring characters or figures 500 that lack variation, making the overall appearance of the nameplate rather humdrum and less attractive.

Therefore, in summary, the conventional nameplate has the following shortcomings:

1. The surface of the transparent plate of the conventional electronic nameplate is smooth and flat, making the nameplate uneasy to use and to achieve remarkable light and colour variations.

2. Although conventional nameplate may include the semitransparent plate to protect the LED portion, the light emitted by the LED portion produces boring characters or figures that lack variation, making the overall appearance of the nameplate rather humdrum and less attractive.

3. The conventional nameplate has no optical display interface and therefore cannot attract attention.

4. During use, the overall appearance of the conventional nameplate is rather humdrum and inaesthetic. It cannot produce glaring visual beauty of advertising as observed from a distance.

What is needed, therefore, is a nameplate that overcomes at least one of the shortcomings described above.

### SUMMARY OF THE INVENTION

In one aspect, embodiments of the present invention provide a displaying gain structure for an electronic nameplate. In particular, the displaying gain structure includes a cover plate mounted to an LED portion on a circuit board through an intermediate member and spaced apart from the circuit board by a distance. The cover plate further includes an optical display interface to enhance an optical gain thereof.

To achieve above object, the present invention provides a displaying gain structure for an electronic nameplate, comprising: a circuit board comprising an LED portion disposed on a front side thereof, and a control element, an information access port, a battery holder and a switch disposed on a back side thereof to control operation of the LED portion; a magnet assembly comprising a magnet unit and a metal sheet disposed on the back side of the circuit board, which is configured to be attached to clothes of a user by attraction between the magnet unit and the metal sheet such that information displayed by the LED portion is observable; and a cover plate fixedly mounted to the LED portion by an intermediate member and spaced apart from the circuit board by a distance, the cover plate further comprising an optical display interface to enhance optical gain thereof, wherein with refraction occurring as light transmits through the optical display interface, the information of the LED portion on the circuit board is presented as characters or figures having a remarkable gain variation effect of being magnified, three dimensional and floating, which produces glaring visual beauty of advertising.

The optical display interface comprises a solid protrusion with a curved outer surface, for producing the remarkable gain variation effect and the glaring visual beauty of advertising. The optical display interface comprises a hollow protrusion with a curved outer surface, for producing the remarkable gain variation effect and the glaring visual beauty of advertising. The optical display interface comprises horizontal stripes, for producing the remarkable gain variation effect and the glaring visual beauty of advertising. The optical display interface comprises inclined stripes, for producing the remarkable gain variation effect and the glaring visual beauty of advertising. The optical display interface comprises spiral stripes, for producing the remarkable gain variation effect and the glaring visual beauty of advertising. The intermediate member comprises a double-sided tape.

According to one embodiment, by using the refraction occurring as light transmits through an optical display interface, information of the LED portion on the circuit board can be presented as characters or figures having a remarkable gain variation effect such as, being magnified, three dimensional and floating, which produces glaring visual beauty of advertising.

### BRIEF DESCRIPTION OF THE DRAWINGS

FIG. 1 illustrates a perspective view of a conventional nameplate.

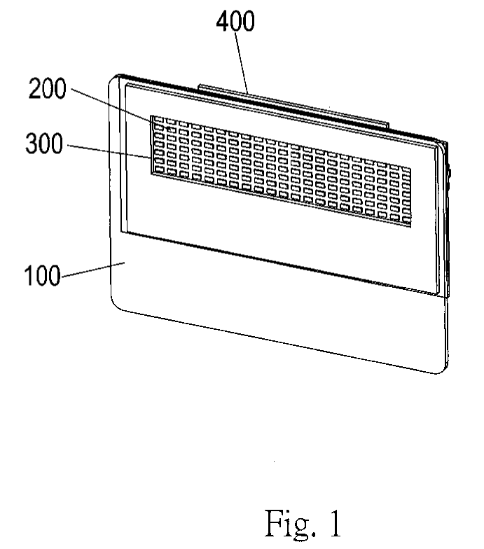

FIG. 2 illustrates a side view of the conventional nameplate.

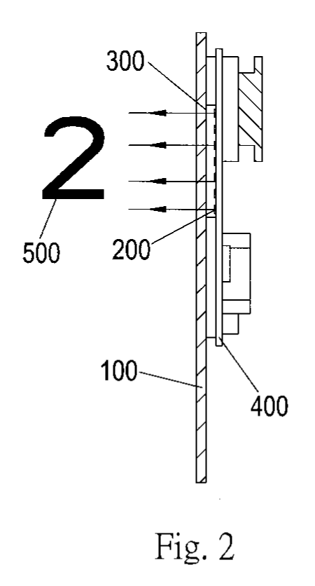

FIG. 3 illustrates an exploded perspective view of the present invention.

FIG. 4 illustrates an assembled perspective view of the present invention.

FIG. 5 illustrates a side view of a first embodiment of the present invention.

FIG. 6 illustrates a side view of a second embodiment of the present invention.

FIG. 7 illustrates a side view of a third embodiment of the present invention.

FIG. 8 illustrates a side view of a fourth embodiment of the present invention.

### DETAILED DESCRIPTION OF THE PREFERRED EMBODIMENTS

In order to make the aforementioned and other features and advantages of the present invention more comprehensible, embodiments accompanied with figures are described in detail below.

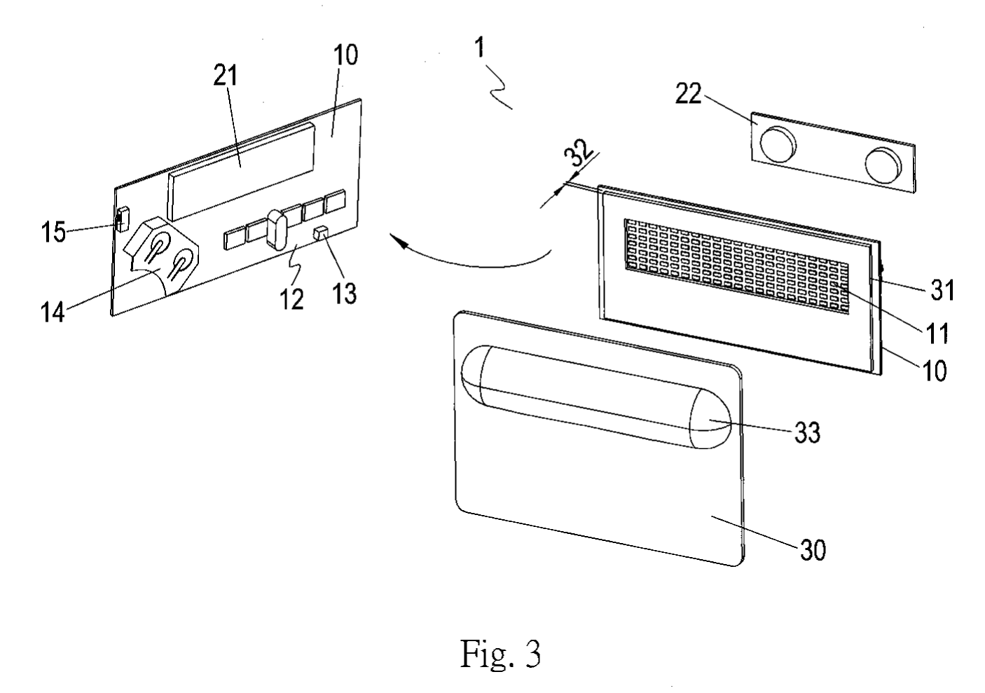

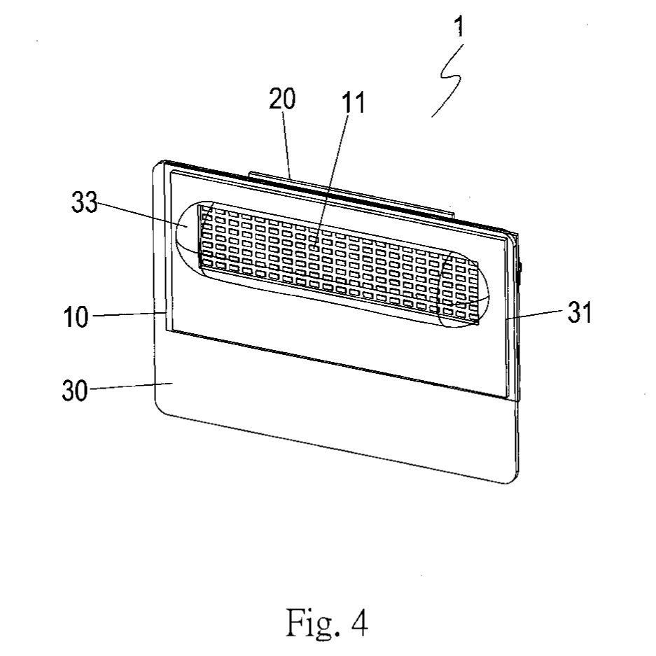

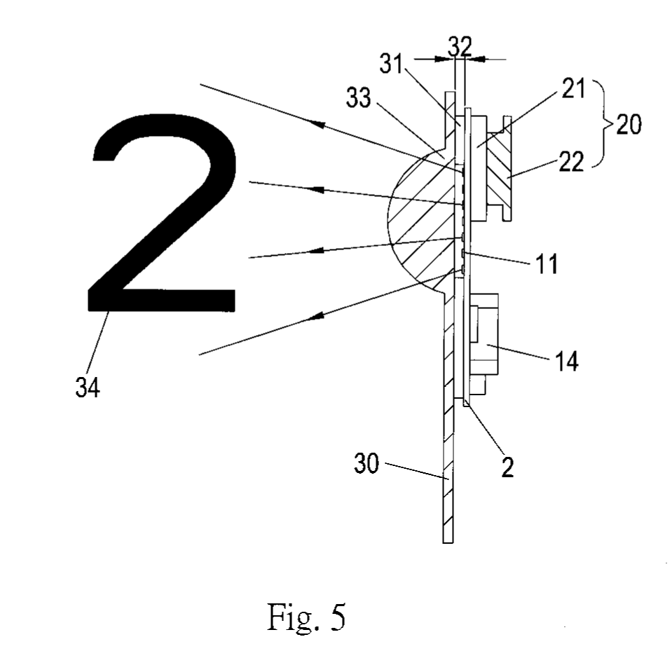

FIGS. 3 through 5 illustrate an exploded perspective view, an assembled perspective view and a side view of a first embodiment of a displaying gain structure for an electronic nameplate, respectively. The displaying gain structure for an electronic nameplate includes a circuit board 10 and a magnet assembly 20.

The circuit board 10 includes an LED portion 11 disposed on a front side thereof, and a control element 12, an information access port 13, a battery holder 14 and a switch 15 disposed on a back side thereof to control operation of the LED portion 11.

The magnet assembly 20 includes a magnet unit 21 and a metal sheet 22 disposed on the back side of the circuit board 10, and is attached to clothes of a user by the attraction between the magnet unit 21 and the metal sheet 22. Thus, the information displayed by the LED portion 11 can be observed.

The displaying gain structure is characterized as including a cover plate 30. The cover plate 30 is fixedly mounted to the LED portion 11 on the circuit board 10 by an intermediate member 31 and spaced apart from the circuit board 10 by a distance 32. In the illustrated embodiment, the intermediate member 31 is a double-sided tape. The cover plate 30 further includes an optical display interface 33 to enhance its optical gain. In the illustrated embodiment, the optical display interface 33 is a solid protrusion with a curved outer surface, for producing a remarkable gain variation effect. Further, with the refraction occurring as the light transmits through the optical display interface, the information of the LED portion 11 on the circuit board can be presented as characters or figures 34 having a remarkable gain variation effect such as, being magnified, three dimensional and floating, which produces glaring visual beauty of advertising.

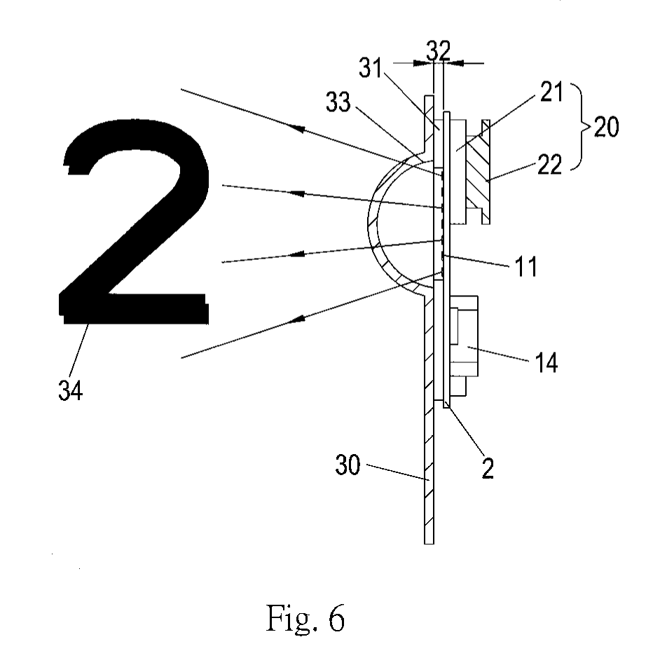

FIG. 6 illustrates a side view of a second embodiment. The optical display interface 33 is a hollow protrusion with a curved outer surface, for producing a remarkable gain variation effect. The information of the LED portion 11 on the circuit board can be presented as characters or figures 34 having a remarkable gain variation effect such as, being magnified and floating, which produces glaring visual beauty of advertising.

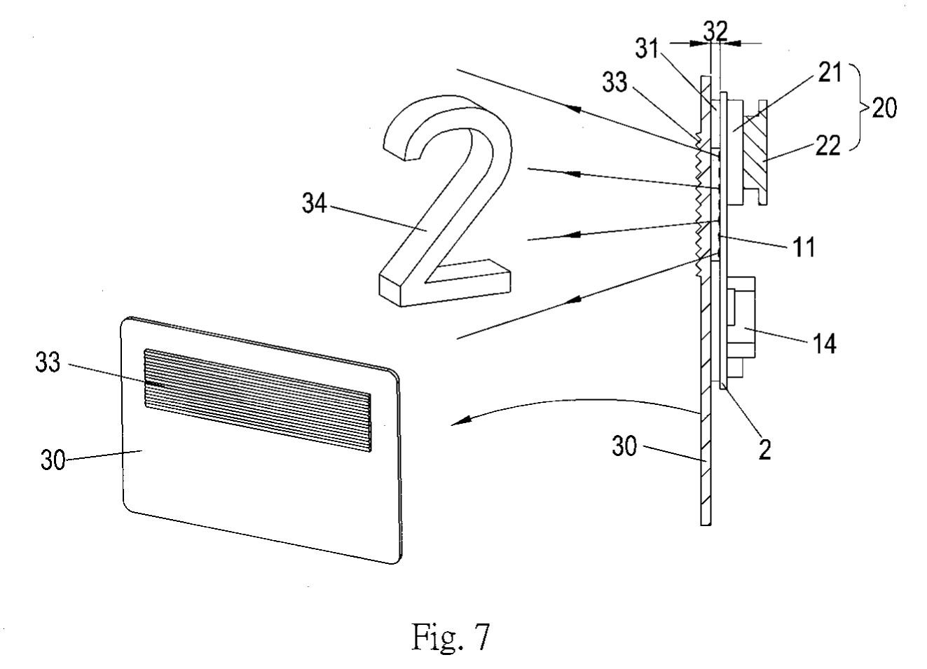

FIG. 7 illustrates a side view of a third embodiment. The optical display interface 33 includes horizontal stripes for producing a remarkable gain variation effect. The information of the LED portion 11 on the circuit board can be presented as characters or figures 34 having a remarkable gain variation effect such as, being magnified and three dimensional, which produces glaring visual beauty of advertising.

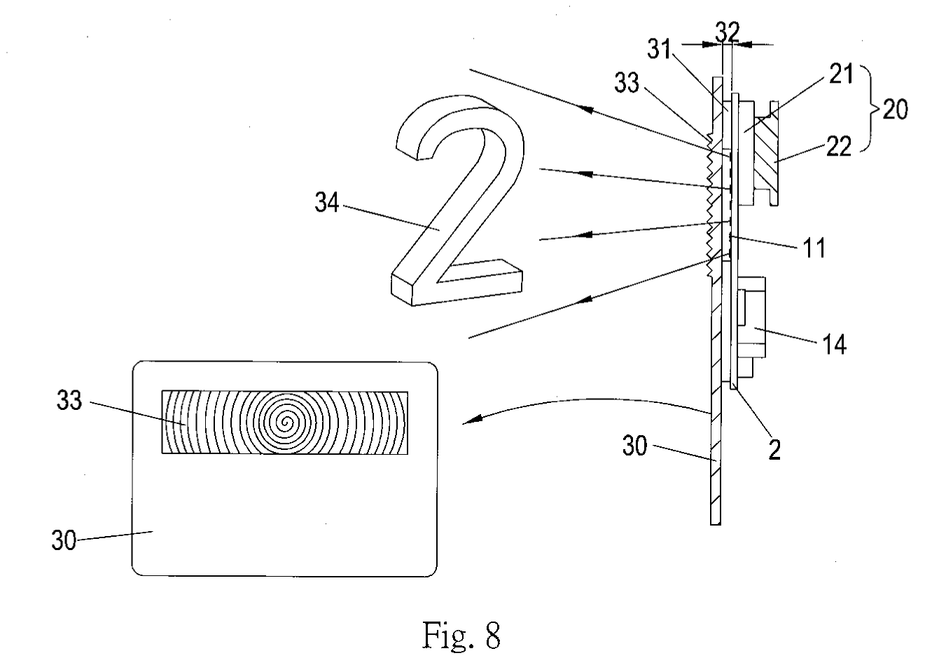

FIG. 8 illustrates a side view of a fourth embodiment. The optical display interface 33 includes spiral stripes for producing a remarkable gain variation effect. The information of the LED portion 11 on the circuit board can be presented as characters or figures 34 having a remarkable gain variation effect such as, being magnified and three dimensional, which produces glaring visual beauty of advertising.

Although the exemplary embodiments of the present invention are described above, it is to be understood that the invention is not limited in its application to the details of construction and the arrangements of the components set forth in the above description or illustrated in the drawings. The invention is capable of other embodiments and of being practiced or being carried out in various ways.

To make the inventiveness and utility of the present invention more comprehensive, at least some of the advantages of the present invention are summarized as follows:

1. The electronic nameplate includes a cover plate with an optical display interface, which is easy to use and to achieve remarkable light and colour variations.

2. The present invention employs the cover plate that can protect the LED portion. Furthermore, the light emitted from the LED portion can be presented as remarkably varied characters or figures, which produces an excellent and attractive overall appearance.

3. The present invention employs the optical display interface that can effectively gain attention. As a result, the consumer may get familiar with the information it presents more quickly, thus adding to its competitiveness.

4. The present invention can produce a beautiful overall appearance during use and can produce glaring visual beauty of advertising as observed from a distance. Further, the present invention is easy to use.

5. The present invention is useful in the business world and industry.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A displaying gain structure for an electronic nameplate, comprising:
a circuit board comprising an LED portion disposed on a front side thereof, and a control element, an information access port, a battery holder and a switch disposed on a back side thereof to control operation of the LED portion;
a magnet assembly comprising a magnet unit and a metal sheet disposed on the back side of the circuit board, which is configured to be attached to clothes of a user by attraction between the magnet unit and the metal sheet such that information displayed by the LED portion is observable; and
a cover plate fixedly mounted to the LED portion by an intermediate member and spaced apart from the circuit board by a distance, the cover plate further comprising an optical display interface to enhance optical gain thereof, wherein with refraction occurring as light transmits through the optical display interface, the information of the LED portion on the circuit board is presented as characters or figures having a remarkable gain variation effect of being magnified, three dimensional and floating, which produces glaring visual beauty of advertising.

2. The displaying gain structure in accordance with claim 1, wherein the optical display interface comprises a solid protrusion with a curved outer surface, for producing the remarkable gain variation effect and the glaring visual beauty of advertising.

3. The displaying gain structure in accordance with claim 1, wherein the optical display interface comprises a hollow protrusion with a curved outer surface, for producing the remarkable gain variation effect and the glaring visual beauty of advertising.

4. The displaying gain structure in accordance with claim 1, wherein the optical display interface comprises horizontal stripes, for producing the remarkable gain variation effect and the glaring visual beauty of advertising.

5. The displaying gain structure in accordance with claim 1, wherein the optical display interface comprises inclined stripes, for producing the remarkable gain variation effect and the glaring visual beauty of advertising.

6. The displaying gain structure in accordance with claim 1, wherein the optical display interface comprises spiral stripes, for producing the remarkable gain variation effect and the glaring visual beauty of advertising.

7. The displaying gain structure in accordance with claim 1, wherein the intermediate member comprises a double-sided tape.
